(19) United States
(12) Patent Application Publication
(10) Pub. No.: US 2025/0001888 A1
(43) Pub. Date: Jan. 2, 2025

(54) VEHICLE-TO-VEHICLE CHARGING DISCONNECT

(71) Applicant: FORD GLOBAL TECHNOLOGIES, LLC, DEARBORN, MI (US)

(72) Inventors: Mohamad Mokbel, Farmington Hills, MI (US); Timothy Harris, Grosse Ile, MI (US); Richard Mo, Canton, MI (US)

(21) Appl. No.: 18/342,982

(22) Filed: Jun. 28, 2023

(51) Int. Cl. B60L 53/57; B60L 53/16; B60L 53/60

(52) U.S. Cl. CPC B60L 53/57; B60L 53/16; B60L 53/60; B60L 53/53

(57) ABSTRACT

Electric vehicle supply equipment includes a cord set having circuitry configured to electrically connect with vehicles to permit the vehicles to exchange power, a power source, and a controller that selectively electrically connects the power source to some of the circuitry based on whether voltages associated with the circuitry are same.

### TECHNICAL FIELD

This disclosure relates to automotive power systems.

### BACKGROUND

Certain charge stations are dedicated infrastructure designed to recharge electric vehicle batteries, and utilize different technologies and charging levels to accommodate various types of electric vehicles and their charging needs. The most common types of charging facilitated by charge stations include Level 1, Level 2, and DC fast charging.

Level 1 charging typically involves plugging the vehicle into a standard household electrical outlet. This charging method is relatively slow, providing a charging rate of around 2-5 miles of range per hour.

Level 2 charging offers a faster charging rate compared to Level 1. It requires a dedicated charging station that operates at higher voltage and current levels. The charging rate typically ranges from 10-60 miles of range per hour.

DC fast charging, also known as Level 3 charging, is the fastest charging option currently available. It employs high-power chargers that deliver direct current (DC) electricity to the vehicle's battery, bypassing the onboard charger. DC fast charging stations are capable of providing a significant amount of charge in a short period, typically offering 80% charge in 30 minutes or less.

In some situations, charge stations may be unavailable.

### SUMMARY

A charge system has electric vehicle supply equipment including a pair of mechanical couplers on opposite ends thereof that each mechanically engage with a charge port of a vehicle and a pair of electrical couplers that each electrically connect with a vehicle such that a pair of vehicles can exchange power, and a controller that, responsive to detecting a difference between voltages associated with the electrical couplers, causes a voltage associated with one of the electrical couplers to change to signal one of the pair of vehicles to discontinue providing power.

A method includes, responsive to detecting a difference between voltages associated with electrical couplers, on opposite ends of electric vehicle supply equipment, that each electrically connect with a vehicle such that a pair of vehicles can exchange power via the electric vehicle supply equipment, causing a voltage associated with one of the electrical couplers to change to signal one of the pair of vehicles to discontinue providing power.

Electric vehicle supply equipment has a cord set including a pair of mechanical couplers that mechanically engage charge ports of vehicles and circuitry that electrically connects with the vehicles to permit the vehicles to power exchange, a power source, and a controller that selectively electrically connects the power source to some of the circuitry based on whether voltages associated with the circuitry are same.

### BRIEF DESCRIPTION OF THE DRAWINGS

FIG. 1 is a block diagram of electric vehicle supply equipment and vehicles.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The J1772 standard, also known as SAE J1772, is an industry standard developed by the Society of Automotive Engineers (SAE) for electric vehicle (EV) charging infrastructure. It establishes a common connector and communication protocol between the EV and the charging station, ensuring compatibility and interoperability among different EV models and charging equipment. It defines both the physical connector and the communication protocol for EV charging. The physical connector includes a standardized plug and receptacle configuration, and features a set of power conductors, signal lines, and a ground connection. The J1772 connector is capable of handling high power levels required for fast charging.

One of the features of the J1772 connector is its pilot signal communication protocol. Communication between the vehicle and the charging station occurs through this pilot signal. It allows the EV and the charging station to negotiate and control various charging parameters such as power level, current flow, and charging mode.

The J1772 standard supports two primary charging modes: Level 1 and Level 2. Level 1 charging operates at standard household AC voltage (120V in North America) as mentioned earlier and typically provides a charging rate of up to 1.4-1.9 kW. Level 2 charging operates at higher voltages (208-240V) and delivers significantly faster charging rates, typically up to 7.2-19.2 kW. The J1772 standard enables Level 2 charging to be widely deployed in various settings, including homes, workplaces, and public charging stations.

In addition to the physical and electrical specifications, the J1772 standard also addresses other considerations. It, for example, includes features like ground fault circuit interrupters (GFCIs), etc.

The J1772 standard has evolved over time to accommodate advancements in EV technology. Initially, it supported AC charging only. However, with the increasing popularity of DC fast charging, an extension to the J1772 standard called Combo or Combo 1 was introduced. The Combo connector combines the J1772 AC connector with two additional DC power conductors, allowing for DC fast charging using the CCS (Combined Charging System) protocol. This extension enables EVs to charge rapidly at high power levels, significantly reducing charging times.

While the J1772 standard has been widely adopted, other standards such as CHAdeMO are also in use, particularly for DC fast charging. To address interoperability challenges, many charging stations feature multiple connectors, including J1772, CHAdeMO, and CCS, allowing a broader range of EVs to charge at the same station.

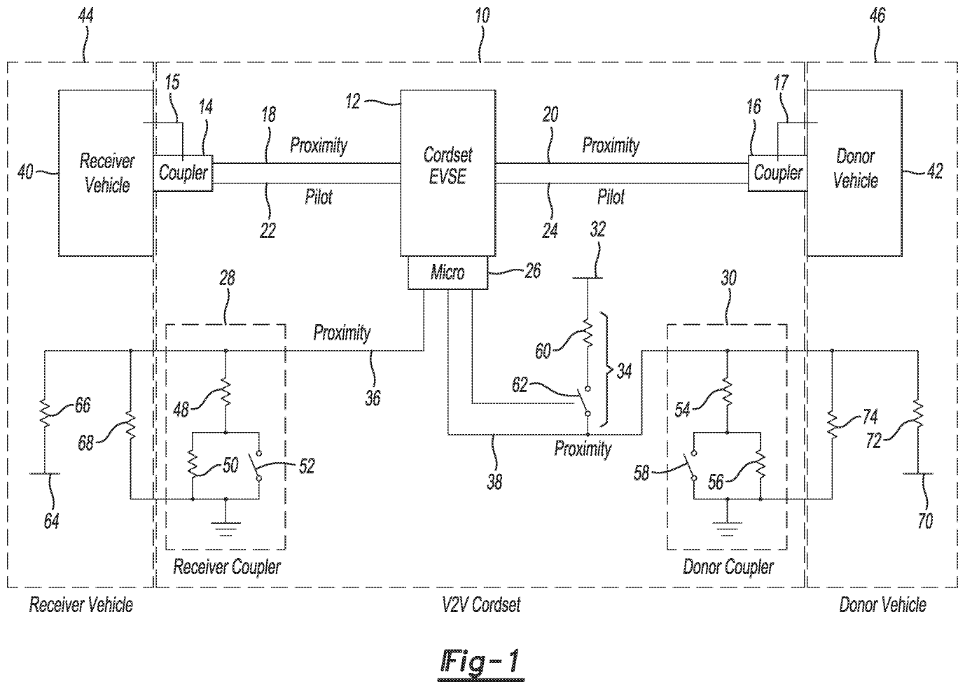

Referring to FIG. 1, electric vehicle supply equipment 10 includes a cord set 12, mechanical couplers 14, 16, proximity lines 18, 20, pilot lines 22, 24, a microcontroller 26, receiver and donor electrical couplers 28, 30, a voltage source 32, switch arrangement 34, and proximity lines 36, 38. The mechanical couplers 14, 16 and receiver and donor electrical couplers 28, 30, in this example, follow the J1772 standard. Other configurations, however, are also contemplated.

The mechanical couplers 14, 16, which include latches 15, 17 respectively, are each configured to engage with charge ports 40, 42 of vehicles 44, 46, respectively. The cord set 12 is thus double-sided. The proximity and pilot lines 18, 22 are connected between the mechanical coupler 14 and cord set 12. The proximity and pilot lines 20, 24 are connected between the cord set 12 and mechanical coupler 14. The proximity lines 18, 20 convey data to the microcontroller 26 regarding whether the mechanical couplers 14, 16 respectively are in a vicinity of the vehicles 44, 46. The pilot lines 22, 24 convey data to the microcontroller 26 regarding whether the mechanical couples 14, 16 are properly engaged with the charge ports 40, 42 and whether communication is established with the vehicles 44, 46. The microcontroller 26 is thus in communication the mechanical couplers 14, 16 and the receiver and donor electrical couplers 28, 30.

The proximity lines 36, 38 convey data regarding the cord set 12 and vehicles 44, 46 as discussed in further detail below.

The receiver electrical coupler 28 includes a pair of resistors 48, 50, and a normally closed switch 52. In this example, the resistor 48 is a 150Ω resistor and the resistor 50 is a 330Ω resistor. The resistor 50 and the normally closed switch 52 are in parallel between the resistor 48 and ground. The resistor 48 is connected between the parallel resistor 50 and normally closed switch 52 and the proximity line 36.

The donor electrical coupler 30 includes a pair of resistors 54, 56, and a normally closed switch 58. In this example, the resistor 54 is a 150Ω 62 resistor and the resistor 56 is a 330Ω resistor. The resistor 56 and the normally closed switch 58 are in parallel between the resistor 54 and ground. The resistor 54 is connected between the parallel resistor 56 and normally closed switch 58 and the proximity line 38.

The switch arrangement 32 includes a resistor 60 and switch 62 in series between the voltage source 32 and proximity line 38. In this example, the voltage source 32 is a 5V source and the resistor 60 is a 175Ω resistor.

The microcontroller 26 is arranged to exert control over the normally closed switches 52, 58 and the switch 62.

The electric vehicle supply equipment 10 can thus be used to permit the vehicle 46 (donor vehicle) to charge the vehicle 44 (receiver vehicle) when charge stations are unavailable. The vehicle 46, however, should be notified when a user disengages the mechanical coupler 14 (and latch 15) from the charge port 40 to signal the vehicle 46 to stop providing charge.

The vehicle 44 includes a voltage source 64 and a pair of resistors 66, 68. In this example, the resistor 66 is a 330Ω resistor and the resistor 68 is a 2.7 kΩ resistor. The resistor 68, when the receiver electrical coupler 28 is properly mated with the vehicle 44, is in parallel with the resistor 48 and the parallel resistor 50 and normally closed switch 52.

The vehicle 46 includes a voltage source 70 and a pair of resistors 72, 74. In this example, the resistor 72 is a 330Ω resistor and the resistor 74 is a 2.7 kΩ resistor. The resistor 74, when the donor electrical coupler 30 is properly mated with the vehicle 46, is in parallel with the resistor 54 and the parallel resistor 56 and normally closed switch 58.

During charge, the latches 15, 17 will be engaged with the charge ports 40, 42 respectively, the voltage on the proximity lines 36, 38 will be 1.5V (because the normally closed switches 52 will be closed), and the switch 62 will be open. That is, the microcontroller 26 will sense, via typical sensors, no difference in voltage on the proximity lines 36, 38.

Given the mechanical coupler 14 and receiver electrical coupler 28 follow the J1772 standard, disengagement of the latch 15 from the charge port 40 will prompt the normally closed switch 52 to open, resulting in a change in voltage on the proximity line 36 from 1.5V to 2.77V. The voltage on the proximity line 38, however, will remain unchanged at 1.5V. Responsive to detecting a difference in voltage between the proximity lines 36, 38, the microcontroller 26 will close the switch 62. This will connect the donor electrical coupler 30 to the voltage source 32, pulling the voltage on the proximity line 38 from 1.5V to 2.77V. Upon detecting this change, the vehicle 46 will stop supplying power to the cord set 12 as the 2.77V on the proximity line 38 mimics the condition when the donor electrical coupler 30 is disconnected from the vehicle 46.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Other circuitry and circuit element values, for example, may be used depending on the charge standard being adhered to, etc.

The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated.

While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A charge system comprising:
electric vehicle supply equipment including a pair of mechanical couplers on opposite ends thereof each configured to mechanically engage with a charge port of a vehicle and a pair of electrical couplers each configured to electrically connect with a vehicle such that a pair of vehicles can exchange power, and a controller programmed to, responsive to detecting a difference between voltages associated with the electrical couplers, cause a voltage associated with one of the electrical couplers to change to signal one of the pair of vehicles to discontinue providing power.

2. The charge system of claim 1, wherein the electric vehicle supply equipment includes a switch and wherein causing the voltage associated with one of the electrical couplers to change includes closing the switch.

3. The charge system of claim 2, wherein the electric vehicle supply equipment includes a voltage source, and wherein closing the switch connects the voltage source to the one of the electrical couplers.

4. The charge system of claim 1, wherein the mechanical couplers each include a latch and wherein the electric vehicle supply equipment is configured such that the voltages associated with the electrical couplers is same while the latches are mechanically engaged with respective charge ports of the pair of vehicles.

5. The charge system of claim 4, wherein the electric vehicle supply equipment is configured such that disengagement of the latch results in a change in voltage associated with at least one of the electrical couplers.

6. The charge system of claim 4, wherein the change is in increase in voltage.

7. A method comprising:
responsive to detecting a difference between voltages associated with electrical couplers, on opposite ends of electric vehicle supply equipment, that are each configured to electrically connect with a vehicle such that a pair of vehicles can exchange power via the electric vehicle supply equipment, causing a voltage associated with one of the electrical couplers to change to signal one of the pair of vehicles to discontinue providing power.

8. The method of claim 7, wherein the causing includes closing a switch of the electric vehicle supply equipment.

9. The method of claim 7, wherein the causing includes connecting a voltage source of the electric vehicle supply equipment to the one of the electrical couplers.

10. The method of claim 7, wherein the voltages are same while latches on the opposite ends of the electric vehicle supply equipment are engaged with charge ports of the pair of vehicles.

11. The method of claim 10, responsive to disengagement of one of the latches, changing a voltage associated with at least one of the electrical couplers.

12. The method of claim 11, wherein the changing is increasing the voltage.

13. Electric vehicle supply equipment comprising:
a cord set including a pair of mechanical couplers configured to mechanically engage charge ports of vehicles and circuitry configured to electrically connect with the vehicles to permit the vehicles to power exchange, a power source, and a controller programmed to selectively electrically connect the power source to some of the circuitry based on whether voltages associated with the circuitry are same.

14. The electric vehicle supply equipment of claim 13, wherein each of the mechanical couplers includes a latch and wherein the cord set is configured such that disengagement of one of the latches results in a change in at least one of the voltages.

15. The electric vehicle supply equipment of claim 14, wherein the change is an increase.

16. The electric vehicle supply equipment of claim 14, wherein the voltages are same during the power exchange.

17. The electric vehicle supply equipment of claim 13 further comprising a switch, wherein selectively electrically connecting the power source to some of the circuitry includes selectively closing the switch.
